(19) United States
(12) Patent Application Publication
(10) Pub. No.: US 2009/0241739 A1
(43) Pub. Date: Oct. 1, 2009

(54) Hand tool with detachable structure for removing a head portion from handle

(76) Inventor: Chih-Ching Hsieh, Taichung (TW)

Correspondence Address: Chien-Hui Su, P. O. Box 70-121 Taichung, Taichung City, 40899, TW

(21) Appl. No.: 11/542,012

(22) Filed: Oct. 2, 2006

(51) Int. Cl. B25B 21/00

(52) U.S. Cl. 81/52

(57) ABSTRACT

A hand tool with a detachable structure for removing a head portion from a handle comprises a handle formed with a pivotal end at one end thereof; the pivotal end being formed with an insertion groove for receiving a tool head; a lateral wall of the pivotal end having a sliding groove for slidably receiving a control unit; a bottom of the sliding groove having a through hole which is communicated to the insertion groove; and the tool head being installed with a combining end; the combining end being installed with a resisting unit. By pushing the control unit to resist against the resisting unit, the resisting unit will separate from the through hole so that the tool head can be replaced. The control unit is pivoted to the sliding groove. The resisting unit is formed by an elastic body and a post.

### FIELD OF THE INVENTION

The present invention relates to hand tools, and particularly to a hand tool with a detachable structure for removing a head portion from a handle, wherein the head is firmly secured to the handle and can be withdraw from the handle quickly and rapidly.

### BACKGROUND OF THE INVENTION

In one design of the hand tools, the handle is detachable from the head portion so that the handle can be assembled with a variety of heads to fit the working conditions and environments.

If the hand tool is a larger one, it is necessary to tightly engage the head to the handle so that the head will not fall down from the head. However this induces a difficult in withdrawing the head from the handle. In one improvement, a resisting unit is installed to the head and it also resists against an inner wall of a recess in the handle so as to fix the head to the handle.

However above mentioned structure has the defects that when it is desired to withdraw the head from the handle, it great force is necessary, but this is possible to hurt the user. Furthermore, the steel ball in the resisting unit is possible to fall out in withdraw the head.

### SUMMARY OF THE INVENTION

Accordingly, the primary object of the present invention is to provide a hand tool with a detachable structure for removing a head portion from a handle, wherein the head is firmly secured to the handle and can be withdraw from the handle quickly and rapidly.

To achieve above objects, the present invention provides a hand tool with a detachable structure for removing a head portion from a handle which comprises a handle formed with a pivotal end at one end thereof; the pivotal end being formed with an insertion groove for receiving a tool head; a lateral wall of the pivotal end having a sliding groove for slidably receiving a control unit; a bottom of the sliding groove having a through hole which is communicated to the insertion groove; and the tool head being installed with a combining end; the combining end being installed with a resisting unit. By pushing the control unit to resist against the resisting unit, the resisting unit will separate from the through hole so that the tool head can be replaced. The control unit is pivoted to the sliding groove. The resisting unit is formed by an elastic body and a post.

The various objects and advantages of the present invention will be more readily understood from the following detailed description when read in conjunction with the appended drawing.

### BRIEF DESCRIPTION OF THE DRAWINGS

FIG. 1 is an explosive schematic view of the insertion type combining assembly of the present invention.

FIGS. 2 to 4 show the operation of the insertion type combining assembly of the present invention.

FIG. 5 is a schematic view showing the second embodiment of the present invention.

FIGS. 6 to 7 are schematic view showing the operation of the second embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

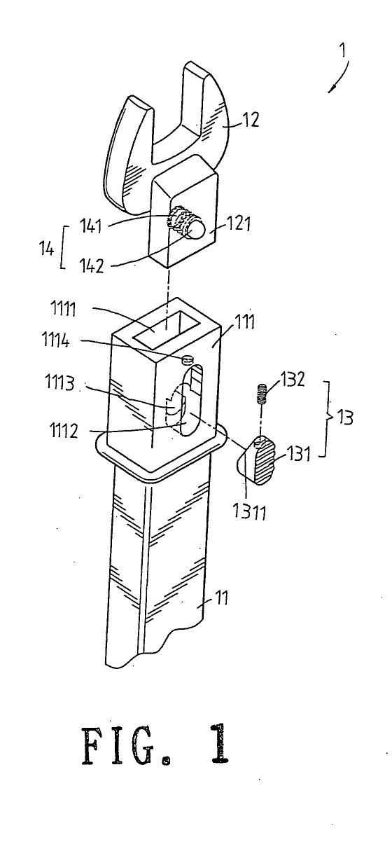

Referring to FIG. 1, an insertion combination tool of the present invention is illustrated. The present invention has the following elements.

A handle 11 is formed with a pivotal end 111 at one end thereof. The pivotal end 111 is formed with an inclined surface 1311. The pivotal end 111 is formed with an insertion groove 1111 for receiving a tool head 12. A lateral wall of the pivotal end 111 has a long sliding groove 1112 for slidably receiving a control unit 13. A bottom of the sliding groove 1112 has a through hole 1113 which is communicated to the insertion groove 1111. The control unit 13 is formed by a push unit 131 and an elastic body 132. The push unit 131 is installed in the sliding groove 1112. A surface of the push unit 131 facing to the through hole 1113 is installed with an inclined surface 1311. The elastic body 132 is received in a recess 1114 of the sliding groove 1112.

The tool head 12 is installed with a combining end 121. The combining end 121 is installed with a resisting unit 14. The resisting unit 14 is formed by an elastic body 141 and a post 142. One end of the elastic body 141 is connected to the combining end 121 and another end thereof is connected to the post 142.

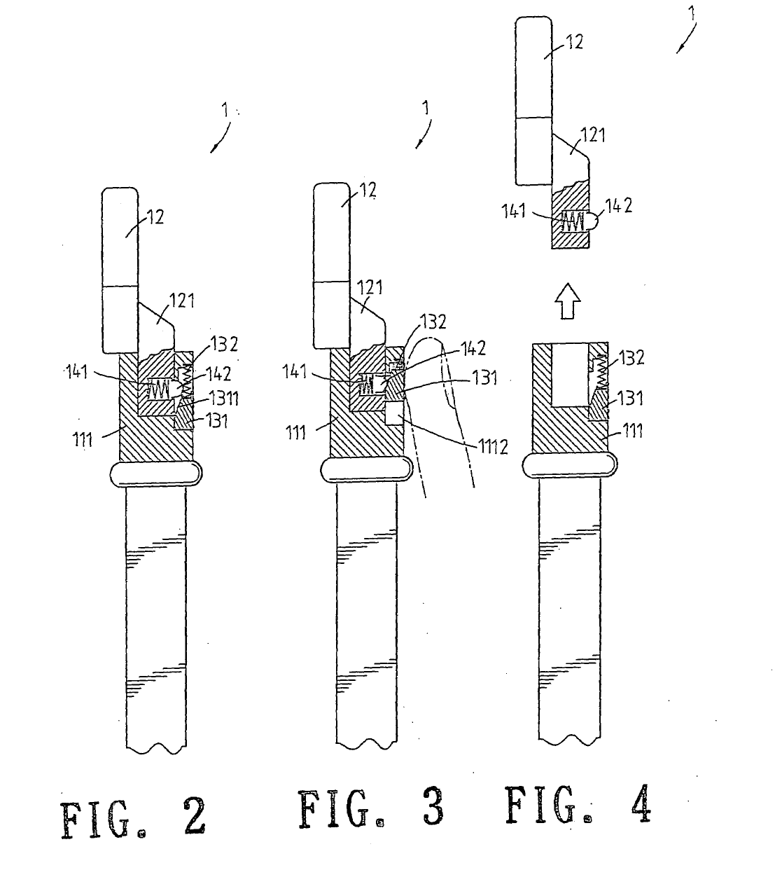

In use, referring to FIGS. 2 to 4, the combining end 121 is combined to the pivotal end 111 and the post 142 passes through the through hole 1113. By the elastic force of the elastic body 141, the post 142 resists against the push unit 131 so as to fix the combining end 121 and the pivotal end 111. When it is desired to remove the tool head 12, the push unit 131 is driven to eject the elastic body 132 so that the post 142 will compress the elastic body 141 and move along the inclined surface 1311 at the bottom of the push unit 131 so as to separate from the through hole 1113. Thus the tool head 12 can be removed.

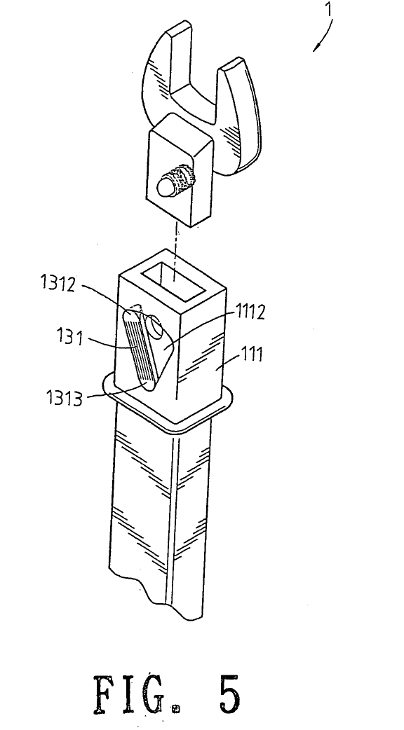

In the second embodiment of the present invention, referring to FIG. 5, those identical to the above embodiment will not be further described herein. Only those different from above embodiment are described. In this embodiment, the sliding groove 1112 has a sector form. The push unit 131 is a long shape. One end of the push unit 131 is a free end 312 and another end thereof is a pivotal end 1313. The pivotal end 1313 is pivotally installed to a top end of the sector sliding groove 1112 so that the free end 1312 can swing in the sliding groove 1112.

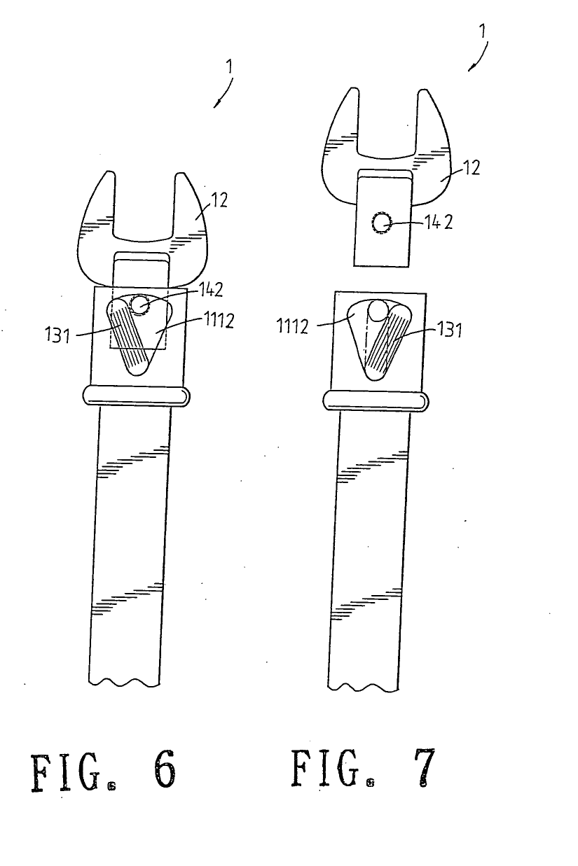

In use of the second embodiment of the present invention, referring to FIGS. 6 and 7, when it is desired to remove the tool head 12, the push unit 131 is pushed so that the free end 1312 slides along the sector area of the sliding groove 1112 and the post 142 moves along the inclined surface 1311 at the bottom of the push unit 131 and separates from the through hole 1113. Then the tool head 12 can be removed.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A hand tool with a detachable structure for removing a head portion from a handle; the hand tool comprising:
a handle formed with a connecting portion at one end thereof; the connecting portion being formed with an insertion groove for receiving a tool head; a lateral wall of the connecting portion having a sliding groove for slidably receiving a control unit; a bottom of the sliding groove having a through hole which is communicated to the insertion groove; and
the tool head being installed with a combining end; the combining end being installed with a resisting unit; and
wherein by pushing the control unit to resist against the resisting unit, the resisting unit will separate from the through hole so that the tool head can be replaced;
wherein the control unit is pivoted to the sliding groove;
wherein the resisting unit is formed by an elastic body and a post;
wherein the control unit includes an elastic body and a push unit and a surface of the push unit corresponding to the through hole is an inclined surface which has a plurality of transversal protrusions; and the push an approximate triangular shape with a large lower side and a small upper side; and
wherein the sliding groove is formed with a groove therein for receiving the elastic body.

2. (canceled)

3. (canceled)

4. (canceled)

5. (canceled)

6. A hand tool with a detachable structure for removing a head portion from a handle; the hand tool comprising:
a handle formed with a connecting portion at one end thereof; the connecting portion being formed with an inclined surface; the connecting portion being formed with an insertion groove for receiving a tool head; a lateral wall of the connecting portion having a sector sliding groove for slidably receiving a control unit; a bottom of the sliding groove having a through hole which is communicated to the insertion groove; the control unit being formed by a push unit; the push unit being installed in the sliding groove; the push unit having a long shape and one end of the push unit is a free end and another end thereof is a pivotal portion; the pivotal portion being pivotally installed to a top end of the sector sliding groove so that the free end can swing in the sliding groove; and
the tool head being installed with a combining end; the combining end being installed with a resisting unit; the resisting unit being formed by an elastic body and a post; one end of the elastic body being connected to the combining end and another end thereof being connected to the post.
